(19) United States
(12) Patent Application Publication
(10) Pub. No.: US 2022/0263415 A1
(43) Pub. Date: Aug. 18, 2022

(54) CONTROLLER APPLIED TO AN INDUCTOR-INDUCTOR-CAPACITOR RESONANT CONVERTER AND OPERATIONAL METHOD THEREOF

(71) Applicant: Leadtrend Technology Corp., Hsinchu County (TW)

(72) Inventors: Chih-Chi Chang, Hsinchu County (TW); Meng-Jen Tsai, Hsinchu County (TW); Yao-Tsung Chen, Hsinchu County (TW); Ming-Chang Tsou, Hsinchu County (TW)

(21) Appl. No.: 17/308,076

(22) Filed: May 5, 2021

(30) Foreign Application Priority Data
Feb. 18, 2021 (TW) 110105502

(51) Int. Cl. H02M 3/335; H02M 1/38; H02M 1/00

(52) U.S. Cl. CPC H02M 3/33571; H02M 1/0058; H02M 1/38

(57) ABSTRACT

A controller applied to a primary side of an inductor-inductor-capacitor (LLC) resonant converter includes a common-mode voltage generation circuit and a control signal generation circuit. The common-mode voltage generation circuit is used for generating a common-mode voltage. The control signal generation circuit is used for generating an upper bridge switch control signal and a lower bridge switch control signal according to a compensation voltage corresponding to an output voltage of the LLC resonant converter, a sensing voltage corresponding to an input voltage of the LLC resonant converter, and the common-mode voltage, wherein the upper bridge switch control signal and the lower bridge switch control signal control an upper bridge switch and a lower bridge switch of the primary side of the LLC resonant converter, respectively.

### BACKGROUND OF THE INVENTION

### 1. Field of the Invention

The present invention relates to a controller applied to an inductor-inductor-capacitor resonant converter and an operational method thereof, and particularly to a controller and an operational method thereof that can utilize a current mode control method to control an inductor-inductor-capacitor resonant converter.

### 2. Description of the Prior Art

In the prior art, a symmetrical inductor-inductor-capacitor (LLC) power converter is a resonant circuit that can control frequencies (frequency regulation) of two power switches of a primary side of the inductor-inductor-capacitor power converter to make dual output voltages of a secondary side of the inductor-inductor-capacitor power converter constant, wherein the inductor-inductor-capacitor power converter can make the inductor-inductor-capacitor power converter have advantages of lower switching loss, higher conversion efficiency, and so on through a soft switching characteristic thereof.

However, when the inductor-inductor-capacitor power converter is controlled by a voltage mode, transient response of the inductor-inductor-capacitor power converter will become slower to make the inductor-inductor-capacitor power converter lose the above-mentioned advantages. Therefore, how to improve a control method of the inductor-inductor-capacitor power converter becomes an important issue of a designer of the inductor-inductor-capacitor power converter.

### SUMMARY OF THE INVENTION

An embodiment of the present invention provides a controller applied to a primary side of an inductor-inductor-capacitor (LLC) resonant converter. The controller includes a common-mode voltage generation circuit and a control signal generation circuit. The common-mode voltage generation circuit is used for generating a common-mode voltage. The control signal generation circuit is used for generating an upper bridge switch control signal and a lower bridge switch control signal according to a compensation voltage corresponding to an output voltage of the LLC resonant converter, a sensing voltage corresponding to an input voltage of the LLC resonant converter, and the common-mode voltage, wherein the upper bridge switch control signal and the lower bridge switch control signal control an upper bridge switch and a lower bridge switch of the primary side of the LLC resonant converter, respectively.

Another embodiment of the present invention provides an operational method of a controller applied to a primary side of an inductor-inductor-capacitor resonant converter, wherein the controller includes a common-mode voltage generation circuit, a compensation voltage generation circuit, and a control signal generation circuit. The operational method includes the compensation voltage generation circuit generating a compensation voltage to the control signal generation circuit according to an output voltage of the LLC resonant converter; the common-mode voltage generation circuit generating a common-mode voltage to the control signal generation circuit; and the control signal generation circuit generating an upper bridge switch control signal and a lower bridge switch control signal according to the compensation voltage, a sensing voltage corresponding to an input voltage of the LLC resonant converter, and the common-mode voltage, wherein the upper bridge switch control signal and the lower bridge switch control signal control an upper bridge switch and a lower bridge switch of the primary side of the LLC resonant converter, respectively.

The present invention provides a controller applied to a primary side of an inductor-inductor-capacitor (LLC) resonant converter and an operational method thereof. The controller and the operational method utilize a common-mode voltage generation circuit to generate a common-mode voltage, utilize a compensation voltage generation circuit to generate a compensation voltage according to an output voltage of the LLC resonant converter, and utilize a control signal generation circuit to generate an upper bridge switch control signal and a lower bridge switch control signal according to the compensation voltage, a sensing voltage corresponding to an input voltage of the LLC resonant converter, and the common-mode voltage, wherein the upper bridge switch control signal and the lower bridge switch control signal control a upper bridge switch and a lower bridge switch of the primary side of the LLC resonant converter, respectively. Therefore, compared to the prior art, because the controller utilizes a current mode control method to control the LLC resonant converter, and a turning-on time of the upper bridge switch control signal is equal to a turning-on time of the lower bridge switch control signal, the controller can make the LLC resonant converter not only have a soft switching characteristic, but also have advantages of lower switching loss, higher conversion efficiency, and so on.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller applied to a primary side of an inductor-inductor-capacitor (LLC) resonant converter according to a first embodiment of the present invention.

FIG. 2 is a diagram illustrating operation of an inductor-capacitor resonant circuit, a primary side winding, a first secondary side winding, and a second secondary side winding when an upper bridge switch of the primary side of the LLC resonant converter is turned on.

FIG. 3 is a diagram illustrating operation of the inductor-capacitor resonant circuit, the primary side winding, the first secondary side winding, and the second secondary side winding when a lower bridge switch of the primary side of the LLC resonant converter is turned on.

FIG. 4 is a diagram illustrating a dead time existing between the turning-on time of the upper bridge switch and the turning-on time of the lower bridge switch.

FIG. 5 is a diagram illustrating the common-mode voltage generation circuit.

FIG. 6 is a diagram illustrating a controller applied to the primary side of the LLC resonant converter according to a second embodiment of the present invention.

FIG. 7 is a diagram illustrating the common-mode voltage generation circuit.

FIG. 8 is a flowchart illustrating an operational method of a controller applied to a primary side of an LLC resonant converter according to a third embodiment of the present invention.

### DETAILED DESCRIPTION

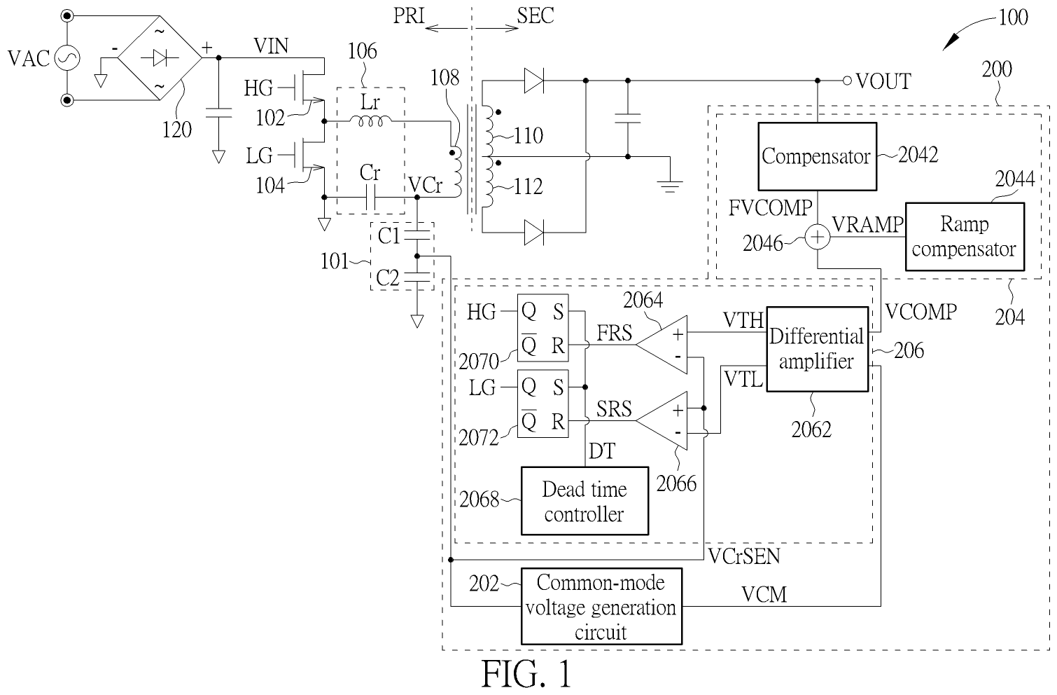

Please refer to FIG. 1. FIG. 1 is a diagram illustrating a controller 200 applied to a primary side PRI of an inductor-inductor-capacitor (LLC) resonant converter 100 according to a first embodiment of the present invention. As shown in FIG. 1, the controller 200 includes a common-mode voltage generation circuit 202, a compensation voltage generation circuit 204, and a control signal generation circuit 206, wherein the common-mode voltage generation circuit 202 is coupled to a voltage divider 101 (composed of capacitors C1, C2) of the primary side PRI of the LLC resonant converter 100, the compensation voltage generation circuit 204 is coupled to a secondary side SEC of the LLC resonant converter 100, and the control signal generation circuit 206 is coupled to the common-mode voltage generation circuit 202, the compensation voltage generation circuit 204, and the primary side PRI of the LLC resonant converter 100. In addition, potential of ground of the primary side PRI of the LLC resonant converter 100 can be the same as or different from potential of ground of the secondary side SEC of the LLC resonant converter 100.

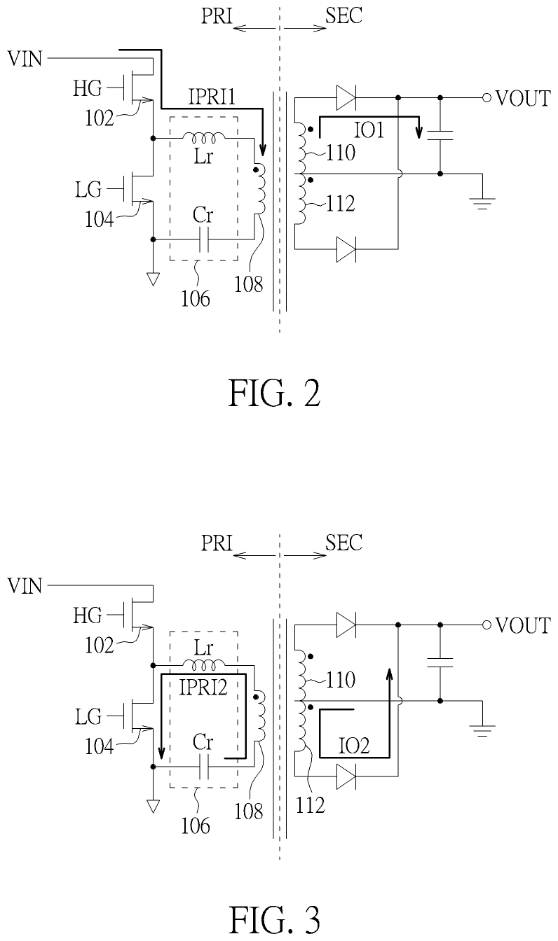

Please refer to FIGS. 2, 3. FIG. 2 is a diagram illustrating operation of an inductor-capacitor resonant circuit 106, a primary side winding 108, a first secondary side winding 110, and a second secondary side winding 112 when an upper bridge switch 102 of the primary side PRI of the LLC resonant converter 100 is turned on, and FIG. 3 is a diagram illustrating operation of the inductor-capacitor resonant circuit 106, the primary side winding 108, the first secondary side winding 110, and the second secondary side winding 112 when a lower bridge switch 104 of the primary side PRI of the LLC resonant converter 100 is turned on, wherein the upper bridge switch 102, the lower bridge switch 104, the inductor-capacitor resonant circuit 106, the primary side winding 108, the first secondary side winding 110, and the second secondary side winding 112 are included in the LLC resonant converter 100, and a magnetizing inductor of the primary side winding 108 is not shown in FIG. 1 for simplicity. As shown in FIG. 2, when the upper bridge switch 102 is turned on (the lower bridge switch 104 is turned off), a primary side current IPRI1 flows through the upper bridge switch 102, an inductor Lr included in the inductor-capacitor resonant circuit 106, and the primary side winding 108 to charge a capacitor Cr included in the inductor-capacitor resonant circuit 106. Meanwhile, because polarity of a voltage of the first secondary side winding 110 is different from polarity of a voltage of the second secondary side winding 112 (as shown in FIG. 1, that the polarity of the voltage of the first secondary side winding 110 is different from the polarity of the voltage of the second secondary side winding 112 can be known by a position of a black spot of the first secondary side winding 110 and a position of a black spot of the second secondary side winding 112), only a first output current IO1 flows through the first secondary side winding 110. That is to say, meanwhile an output voltage VOUT of the secondary side SEC of the LLC resonant converter 100 is generated by a direct current (DC) voltage VIN, the inductor Lr, the primary side winding 108, and the first secondary side winding 110. In addition, the DC voltage VIN is generated by an input voltage VAC (alternating voltage) being rectified by a bridge rectifier 120. In addition, as shown in FIG. 3, when the lower bridge switch 104 is turned on (the upper bridge switch 102 is turned off), the capacitor Cr starts to be discharged, resulting in a primary side current IPRI2 flowing through the primary side winding 108, the inductor Lr, and the lower bridge switch 104. Meanwhile, because the polarity of the voltage of the first secondary side winding 110 is different from the polarity of the voltage of the second secondary side winding 112, only a second output current IO2 flows through the second secondary side winding 112. That is to say, meanwhile the output voltage VOUT can be generated by charges stored in the capacitor Cr, the inductor Lr, the primary side winding 108, and the second secondary side winding 112. Therefore, a cross voltage VCr on the capacitor Cr can be generated according to the operation shown in FIGS. 2, 3, wherein the cross voltage VCr is related to the DC voltage VIN and the cross voltage VCr is a sine wave. As shown in FIG. 1, because the cross voltage VCr is a sine wave, a sensing voltage VCrSEN generated by the voltage divider 101 according to the cross voltage VCr is also a sine wave, and is also related to the DC voltage VIN.

In addition, as shown in FIG. 4, a turning-on time TON1 of an upper bridge switch control signal HG is equal to a turning-on time TON2 of a lower bridge switch control signal LG, the upper bridge switch 102 and the lower bridge switch 104 are not turned on simultaneously, and a dead time DT exists between the turning-on time TON1 of the upper bridge switch control signal HG and the turning-on time TON2 of the lower bridge switch control signal LG, wherein the upper bridge switch control signal HG is applied to a gate of the upper bridge switch 102 and the lower bridge switch control signal LG is applied to a gate of the lower bridge switch 104.

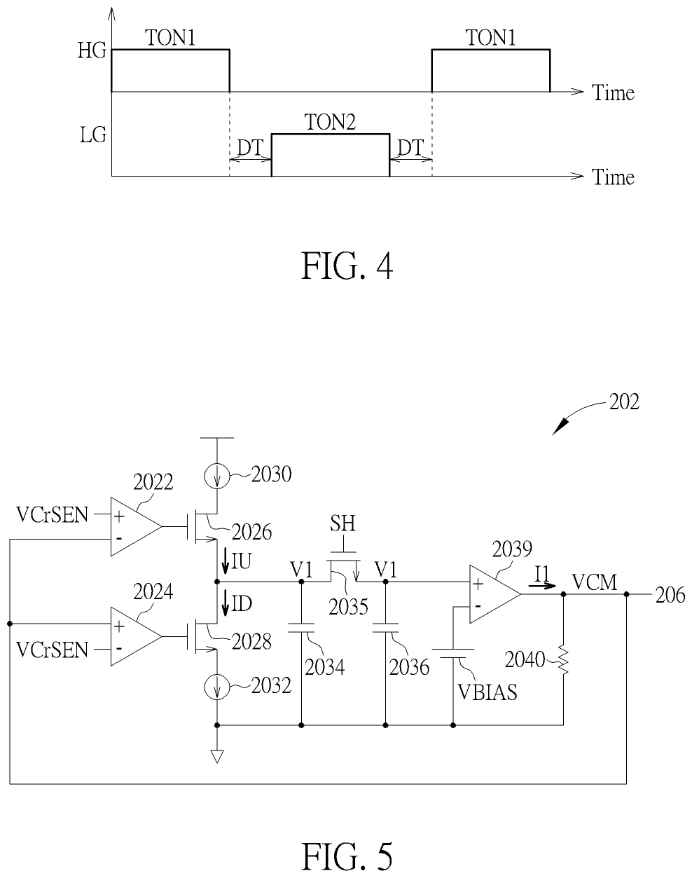

Please refer to FIG. 5. FIG. 5 is a diagram illustrating the common-mode voltage generation circuit 202. As shown in FIG. 5, the common-mode voltage generation circuit 202 includes a first comparator 2022, a second comparator 2024, a first switch 2026, a second switch 2028, a first current source 2030, a second current source 2032, a first capacitor 2034, a third switch 2035, a second capacitor 2036, a DC bias VBIAS, a voltage-to-current converter 2039, and a resistor 2040, wherein coupling relationships between the first comparator 2022, the second comparator 2024, the first switch 2026, the second switch 2028, the first current source 2030, the second current source 2032, the first capacitor 2034, the third switch 2035, the second capacitor 2036, the DC bias VBIAS, and the resistor 2040 can be referred to FIG. 5, so further description thereof is omitted for simplicity. As shown in FIG. 5, the first comparator 2022 can control the first switch 2026 to make a charging current IU provided by the first current source 2030 charge the first capacitor 2034 according to the sensing voltage VCrSEN and a common-mode voltage VCM, and the second comparator 2024 can control the second switch 2028 to make a discharging current ID provided by the second current source 2032 discharge the first capacitor 2034 according to the sensing voltage VCrSEN and the common-mode voltage VCM, wherein when increased charges of the first capacitor 2034 due to the charging current IU is equal to decreased charges of the first capacitor 2034 due to the discharging current ID, a sampling signal SH controlling turning-on of the third switch 2035 can be enabled to make a first voltage V1 of the first capacitor 2034 be sampled and transmitted to the second capacitor 2036. Then, the voltage-to-current converter 2039 can generate a first current I1 according to the first voltage V1, and the first current I1 and the resistor 2040 can determine the common-mode voltage VCM. In addition, because the common-mode voltage generation circuit 202 is well-known to one of ordinary skill in the art, the present invention is not limited to the common-mode voltage generation circuit 202 shown in FIG. 5. That is to say, any configuration in which a circuit can generate the common-mode voltage VCM according to the sensing voltage VCrSEN falls within the scope of the present invention.

In addition, as shown in FIG. 1, the compensation voltage generation circuit 204 includes a compensator 2042, a ramp compensator 2044, and an adder 2046, wherein the compensator 2042 is coupled to the secondary side SEC of the LLC resonant converter 100, and the compensator 2042 generates a first compensation voltage FVCOMP corresponding to the output voltage VOUT according to the output voltage VOUT. In addition, the compensator 2042 has an isolation device which isolates the primary side PRI of the LLC resonant converter 100 from the secondary side SEC of the LLC resonant converter 100. In one embodiment of the present invention, the isolation device is a photo coupler. But, the present invention is not limited to the isolation device being a photo coupler. That is, in another embodiment of the present invention, the isolation device can be another device for isolating the primary side PRI of the LLC resonant converter 100 from the secondary side SEC of the LLC resonant converter 100. As shown in FIG. 1, the adder 2046 is coupled to the compensator 2042, the ramp compensator 2044, and the control signal generation circuit 206, wherein the adder 2046 is used for adding up the first compensation voltage FVCOMP and a ramp voltage VRAMP generated by the ramp compensator to generate a compensation voltage VCOMP to the control signal generation circuit 206. Because the first compensation voltage FVCOMP is related to the output voltage VOUT, and the adder 2046 adds up the first compensation voltage FVCOMP and the ramp voltage VRAMP to generate the compensation voltage VCOMP, the compensation voltage VCOMP is also related to the output voltage VOUT. In addition, because the adder 2046 can add up the first compensation voltage FVCOMP and the ramp voltage VRAMP to generate the compensation voltage VCOMP, the compensation voltage VCOMP can be changed with the ramp voltage VRAMP. Therefore, the control signal generation circuit 206 can control the turning-on time TON1 of the upper bridge switch control signal HG and the turning-on time TON2 of the lower bridge switch control signal LG through the compensation voltage VCOMP being changed with the ramp voltage VRAMP. That is to say, the control signal generation circuit 206 can utilize the compensation voltage VCOMP being changed with the ramp voltage VRAMP to control a minimum operating frequency of the LLC resonant converter 100.

In addition, as shown in FIG. 1, the control signal generation circuit 206 includes a differential amplifier 2062, a first comparator 2064, a second comparator 2066, a dead time controller 2068, an upper bridge switch control signal generator 2070, and a lower bridge switch control signal generator 2072, wherein coupling relationships between the differential amplifier 2062, the first comparator 2064, the second comparator 2066, the dead time controller 2068, the upper bridge switch control signal generator 2070, and the lower bridge switch control signal generator 2072 can be referred to FIG. 1, so further description thereof is omitted for simplicity. As shown in FIG. 1, the differential amplifier 2062 is coupled to the adder 2046 and the common-mode voltage generation circuit 202, wherein the differential amplifier 2062 is used for generating an upper limit voltage VTH and a lower limit voltage VTL according to the compensation voltage VCOMP, the common-mode voltage VCM, and equation (1), and A shown in equation (1) is a gain of the differential amplifier 2062:

VTH=(VCOMP−VCM)×A+VCM

VTL=VCM—(VCOMP−VCM)×A (1)

The first comparator 2064 is coupled to the differential amplifier 2062 and the voltage divider 101, wherein the first comparator 2064 is used for generating a first reset signal FRS according to the upper limit voltage VTH and the sensing voltage VCrSEN; the second comparator 2066 is coupled to the differential amplifier 2062 and the voltage divider 101, wherein the second comparator 2066 is used for generating a second reset signal SRS according to the lower limit voltage VTL and the sensing voltage VCrSEN; the dead time controller 2068 is used for generating the dead time DT; the upper bridge switch control signal generator 2070 is coupled to the first comparator 2064 and the dead time controller 2068, wherein the upper bridge switch control signal generator 2070 is used for generating the upper bridge switch control signal HG according to the first reset signal FRS and the dead time DT; and the lower bridge switch control signal generator 2072 is coupled to the second comparator 2066 and the dead time controller 2068, wherein the lower bridge switch control signal generator 2072 is used for generating the lower bridge switch control signal LG according to the second reset signal SRS and the dead time DT. In addition, the upper bridge switch control signal generator 2070 and the lower bridge switch control signal generator 2072 are SR flip flops. As shown in FIG. 1, because the first reset signal FRS and the dead time DT are inputted to a terminal R and a terminal S of the upper bridge switch control signal generator 2070, respectively, the first reset signal FRS can make the upper bridge switch control signal HG turned off and the dead time DT can make the upper bridge switch control signal HG turned on. That is, the first reset signal FRS and the dead time DT can control the turning-on time TON1 of the upper bridge switch control signal HG; and because the second reset signal SRS and the dead time DT are inputted to a terminal R and a terminal S of the lower bridge switch control signal generator 2072, respectively, the second reset signal SRS can make the lower bridge switch control signal LG turned off and the dead time DT can make the lower bridge switch control signal LG turned on. That is, the second reset signal SRS and the dead time DT can control the turning-on time TON2 of the lower bridge switch control signal LG.

Therefore, the control signal generation circuit 206 can utilize the upper bridge switch control signal HG and the lower bridge switch control signal LG to control turning-on and turning-off of the upper bridge switch 102 and the lower bridge switch 104 of the primary side PRI of the LLC resonant converter 100, respectively. The above-mentioned control method of the controller 200 controlling the LLC resonant converter 100 is a current mode control method. Because the controller 200 utilizes the current mode control method to control the LLC resonant converter 100, and the turning-on time TON1 of the upper bridge switch control signal HG is equal to the turning-on time TON2 of the lower bridge switch control signal LG, the controller 200 can make the LLC resonant converter 100 not only have a soft switching characteristic, but also have advantages of lower switching loss, higher conversion efficiency, and so on.

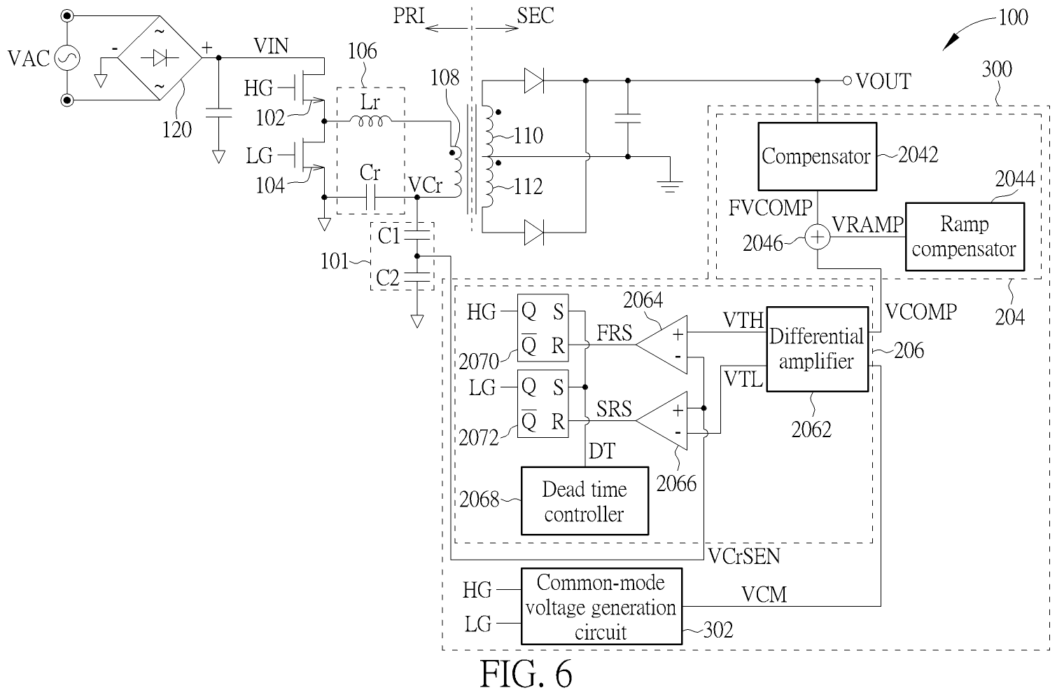

Please refer to FIG. 6. FIG. 6 is a diagram illustrating a controller 300 applied to the primary side PRI of the LLC resonant converter 100 according to a second embodiment of the present invention. As shown in FIG. 6, a difference between the controller 300 and the controller 200 is that a common-mode voltage generation circuit 302 included in the controller 300 is different from the common-mode voltage generation circuit 202. As shown in FIG. 4, because the turning-on time TON1 of the upper bridge switch control signal HG is equal to the turning-on time TON2 of the lower bridge switch control signal LG, and the upper bridge switch control signal HG and the lower bridge switch control signal LG are not enabled simultaneously, the common-mode voltage generation circuit 302 can generate the common-mode voltage VCM according to the upper bridge switch control signal HG and the lower bridge switch control signal LG.

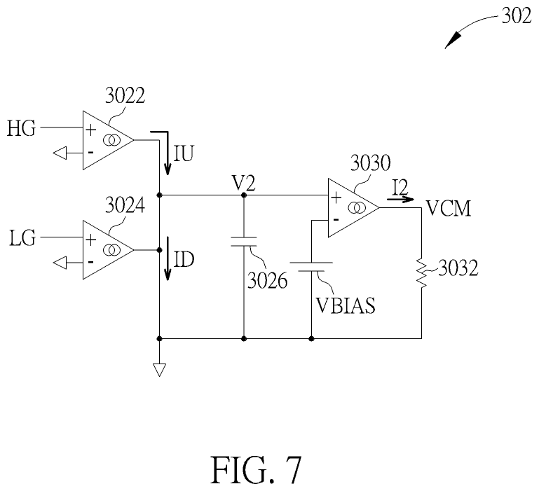

Please refer to FIG. 7. FIG. 7 is a diagram illustrating the common-mode voltage generation circuit 302. As shown in FIG. 7, the common-mode voltage generation circuit 302 includes a first voltage-to-current converter 3022, a second voltage-to-current converter 3024, a first capacitor 3026, a DC bias VBIAS, a third voltage-to-current converter 3030, and a resistor 3032, wherein coupling relationships between the first voltage-to-current converter 3022, the second voltage-to-current converter 3024, the first capacitor 3026, the DC bias VBIAS, the third voltage-to-current converter 3030, and the resistor 3032 can be referred to FIG. 7, so further description thereof is omitted for simplicity. As shown in FIG. 7, the first voltage-to-current converter 3022 can generate the charging current IU according to the upper bridge switch control signal HG, and the second voltage-to-current converter 3024 can generate the discharging current ID according to the lower bridge switch control signal LG. In addition, as shown in FIG. 4, because the upper bridge switch control signal HG and the lower bridge switch control signal LG are not enabled simultaneously, the charging current IU and the discharging current ID do not charge/discharge the first capacitor 3026 at the same time. In addition, because the turning-on time TON1 of the upper bridge switch control signal HG is equal to the turning-on time TON2 of the lower bridge switch control signal LG, a voltage of the first capacitor 3026 can be maintained at a second voltage V2. Then, the third voltage-to-current converter 3030 can generate a second current I2 according to the second voltage V2, and the second current I2 and the resistor 3032 can determine the common-mode voltage VCM. In addition, subsequent operational principles of the controller 300 are the same as those of the controller 200, so further description thereof is omitted for simplicity.

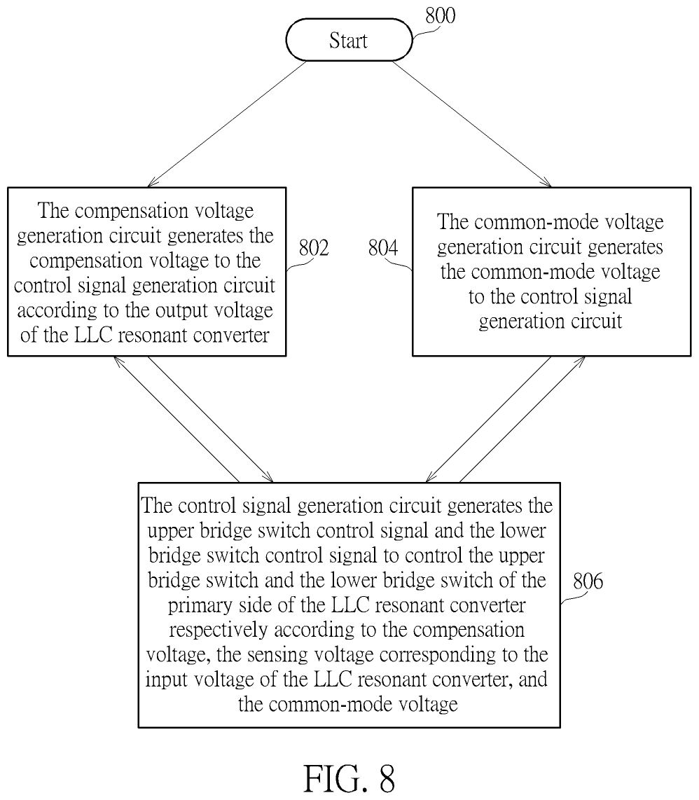

In addition, please refer to FIGS. 1, 4-8. FIG. 8 is a flowchart illustrating an operational method of a controller applied to a primary side of an LLC resonant converter according to a third embodiment of the present invention. The operational method in FIG. is illustrated using the LLC resonant converter 100 and the controller 200 in FIG. 1. Detailed steps are as follows:

Step 800: Start.

Step 802: The compensation voltage generation circuit 204 generates the compensation voltage VCOMP to the control signal generation circuit 206 according to the output voltage VOUT of the LLC resonant converter 100.

Step 804: The common-mode voltage generation circuit 202 generates the common-mode voltage VCM to the control signal generation circuit 206.

Step 806: The control signal generation circuit 206 generates the upper bridge switch control signal HG and the lower bridge switch control signal LG to control the upper bridge switch 102 and the lower bridge switch 104 of the primary side PRI of the LLC resonant converter 100 respectively according to the compensation voltage VCOMP, the sensing voltage VCrSEN corresponding to the input voltage VIN of the LLC resonant converter 100, and the common-mode voltage VCM, go to Step 802 and Step 804.

In Step 802, as shown in FIG. 1, the compensator 2042 of the compensation voltage generation circuit 204 can generate the first compensation voltage FVCOMP corresponding to the output voltage VOUT according to the output voltage VOUT. In addition, the compensator 2042 has the isolation device which isolates the primary side PRI of the LLC resonant converter 100 from the secondary side SEC of the LLC resonant converter 100. As shown in FIG. 1, the adder 2046 of the compensation voltage generation circuit 204 can add up the first compensation voltage FVCOMP and the ramp voltage VRAMP to generate the compensation voltage VCOMP to the control signal generation circuit 206. Because the first compensation voltage FVCOMP is related to the output voltage VOUT, and the adder 2046 adds up the first compensation voltage FVCOMP and the ramp voltage VRAMP to generate the compensation voltage VCOMP, the compensation voltage VCOMP is also related to the output voltage VOUT. In addition, because the adder 2046 can add up the first compensation voltage FVCOMP and the ramp voltage VRAMP to generate the compensation voltage VCOMP, the compensation voltage VCOMP can be changed with the ramp voltage VRAMP. Therefore, the control signal generation circuit 206 can control the turning-on time TON1 of the upper bridge switch control signal HG and the turning-on time TON2 of the lower bridge switch control signal LG through the compensation voltage VCOMP being changed with the ramp voltage VRAMP. That is to say, the control signal generation circuit 206 can utilize the compensation voltage VCOMP being changed with the ramp voltage VRAMP to control the minimum operating frequency of the LLC resonant converter 100.

In Step 804, as shown in FIG. 5, the first comparator 2022 can control the first switch 2026 to make the charging current IU provided by the first current source 2030 charge the first capacitor 2034 according to the sensing voltage VCrSEN and the common-mode voltage VCM, and the second comparator 2024 can control the second switch 2028 to make the discharging current ID provided by the second current source 2032 discharge the first capacitor 2034 according to the sensing voltage VCrSEN and the common-mode voltage VCM, wherein when increased charges of the first capacitor 2034 due to the charging current IU is equal to decreased charges of the first capacitor 2034 due to the discharging current ID, the sampling signal SH controlling turning-on of the third switch 2035 can be enabled to make the first voltage V1 of the first capacitor 2034 be sampled and transmitted to the second capacitor 2036. Then, the voltage-to-current converter 2039 can generate the first current I1 according to the first voltage V1, and the first current I1 and the resistor 2040 can determine the common-mode voltage VCM.

In addition, in another embodiment of the present invention, as shown in FIGS. 6, 7, the common-mode voltage generation circuit 302 can generate the common-mode voltage VCM according to the upper bridge switch control signal HG and the lower bridge switch control signal LG. As shown in FIG. 7, the first voltage-to-current converter 3022 can generate the charging current IU according to the upper bridge switch control signal HG, and the second voltage-to-current converter 3024 can generate the discharging current ID according to the lower bridge switch control signal LG. In addition, as shown in FIG. 4, because the upper bridge switch control signal HG and the lower bridge switch control signal LG are not enabled simultaneously, the charging current IU and the discharging current ID do not charge/discharge the first capacitor 3026 at the same time. In addition, because the turning-on time TON1 of the upper bridge switch control signal HG is equal to the turning-on time TON2 of the lower bridge switch control signal LG, the voltage of the first capacitor 3026 can be maintained at the second voltage V2. Then, the third voltage-to-current converter 3030 can generate the second current I2 according to the second voltage V2, and the second current I2 and the resistor 3032 can determine the common-mode voltage VCM.

In Step 806, as shown in FIG. 1, the differential amplifier 2062 can generate the upper limit voltage VTH and the lower limit voltage VTL according to the compensation voltage VCOMP, the common-mode voltage VCM, and equation (1); the first comparator 2064 can generate the first reset signal FRS according to the upper limit voltage VTH and the sensing voltage VCrSEN; the second comparator 2066 can generate the second reset signal SRS according to the lower limit voltage VTL and the sensing voltage VCrSEN; the dead time controller 2068 can generate the dead time DT; the upper bridge switch control signal generator 2070 can generate the upper bridge switch control signal HG according to the first reset signal FRS and the dead time DT; and the lower bridge switch control signal generator 2072 can generate the lower bridge switch control signal LG according to the second reset signal SRS and the dead time DT. As shown in FIG. 1, because the first reset signal FRS and the dead time DT are inputted to the terminal R and the terminal S of the upper bridge switch control signal generator 2070, respectively, the first reset signal FRS can make the upper bridge switch control signal HG turned off and the dead time DT can make the upper bridge switch control signal HG turned on. That is, the first reset signal FRS and the dead time DT can control the turning-on time TON1 of the upper bridge switch control signal HG; and because the second reset signal SRS and the dead time DT are inputted to the terminal R and the terminal S of the lower bridge switch control signal generator 2072, respectively, the second reset signal SRS can make the lower bridge switch control signal LG turned off and the dead time DT can make the lower bridge switch control signal LG turned on. That is, the second reset signal SRS and the dead time DT can control the turning-on time TON2 of the lower bridge switch control signal LG.

Therefore, the control signal generation circuit 206 can utilize the upper bridge switch control signal HG and the lower bridge switch control signal LG to control turning-on and turning-off of the upper bridge switch 102 and the lower bridge switch 104 of the primary side PRI of the LLC resonant converter 100, respectively. The above-mentioned control method of the controller 200 controlling the LLC resonant converter 100 is the current mode control method.

To sum up, the controller applied to the LLC resonant converter and the operational method utilize the common-mode voltage generation circuit to generate the common-mode voltage, utilize the compensation voltage generation circuit to generate the compensation voltage according to the output voltage, and utilize the control signal generation circuit to generate the upper bridge switch control signal and the lower bridge switch control signal according to the compensation voltage, the sensing voltage, and the common-mode voltage, wherein the upper bridge switch control signal and the lower bridge switch control signal control the upper bridge switch and the lower bridge switch, respectively. Therefore, compared to the prior art, because the controller utilizes the current mode control method to control the LLC resonant converter, and the turning-on time of the upper bridge switch control signal is equal to the turning-on time of the lower bridge switch control signal, the controller can make the LLC resonant converter not only have a soft switching characteristic, but also have advantages of lower switching loss, higher conversion efficiency, and so on.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller applied to a primary side of an inductor-inductor-capacitor (LLC) resonant converter, comprising:
a common-mode voltage generation circuit for generating a common-mode voltage; and
a control signal generation circuit for generating an upper bridge switch control signal and a lower bridge switch control signal according to a compensation voltage corresponding to an output voltage of the LLC resonant converter, a sensing voltage corresponding to an input voltage of the LLC resonant converter, and the common-mode voltage, wherein the upper bridge switch control signal and the lower bridge switch control signal control an upper bridge switch and a lower bridge switch of the primary side of the LLC resonant converter, respectively.

2. The controller of claim 1, further comprising:
a compensation voltage generation circuit coupled to a secondary side of the LLC resonant converter and the control signal generation circuit, wherein the compensation voltage generation circuit generates the compensation voltage to the control signal generation circuit according to the output voltage.

3. The controller of claim 2, wherein the compensation voltage generation circuit comprises:
a compensator coupled to the secondary side of the LLC resonant converter, wherein the compensator generates a first compensation voltage corresponding to the output voltage according to the output voltage, and the compensator has an isolation device which isolates the primary side of the LLC resonant converter from the secondary side of the LLC resonant converter;
a ramp compensator for generating a ramp voltage; and
an adder coupled to the compensator, the ramp compensator, and the control signal generation circuit, wherein the adder adds up the first compensation voltage and the ramp voltage to generate the compensation voltage.

4. The controller of claim 3, wherein the ramp voltage is used for controlling a minimum operating frequency of the LLC resonant converter.

5. The controller of claim 1, wherein the control signal generation circuit comprises:
a differential amplifier coupled to the compensation voltage generation circuit and the common-mode voltage generation circuit, wherein the differential amplifier generates an upper limit voltage and a lower limit voltage according to the compensation voltage and the common-mode voltage;
a first comparator coupled to the differential amplifier, wherein the first comparator generates a first reset signal according to the upper limit voltage and the sensing voltage;
a second comparator coupled to the differential amplifier, wherein the second comparator generates a second reset signal according to the lower limit voltage and the sensing voltage;
a dead time controller for generating a dead time;
an upper bridge switch control signal generator coupled to the first comparator and the dead time controller, wherein the upper bridge switch control signal generator generates the upper bridge switch control signal according to the first reset signal and the dead time; and
a lower bridge switch control signal generator coupled to the second comparator and the dead time controller, wherein the lower bridge switch control signal generator generates the lower bridge switch control signal according to the second reset signal and the dead time.

6. The controller of claim 1, wherein the common-mode voltage generation circuit generates the common-mode voltage according to the sensing voltage.

7. The controller of claim 1, wherein the common-mode voltage generation circuit generates the common-mode voltage according to the upper bridge switch control signal and the lower bridge switch control signal.

8. The controller of claim 1, wherein the controller controls the LLC resonant converter by a current mode.

9. The controller of claim 1, wherein the upper bridge switch and the lower bridge switch are not turned on simultaneously.

10. The controller of claim 1, wherein a dead time exists between turning-on time of the upper bridge switch and turning-on time of the lower bridge switch, and the turning-on time of the upper bridge switch is equal to the turning-on time of the lower bridge switch.

11. An operational method of a controller applied to a primary side of an inductor-inductor-capacitor (LLC) resonant converter, wherein the controller comprises a common-mode voltage generation circuit, a compensation voltage generation circuit, and a control signal generation circuit, the operational method comprising:
the compensation voltage generation circuit generating a compensation voltage to the control signal generation circuit according to an output voltage of the LLC resonant converter;
the common-mode voltage generation circuit generating a common-mode voltage to the control signal generation circuit; and
the control signal generation circuit generating an upper bridge switch control signal and a lower bridge switch control signal according to the compensation voltage, a sensing voltage corresponding to an input voltage of the LLC resonant converter, and the common-mode voltage, wherein the upper bridge switch control signal and the lower bridge switch control signal control an upper bridge switch and a lower bridge switch of the primary side of the LLC resonant converter, respectively.

12. The operational method of claim 11, wherein the compensation voltage generation circuit generating the compensation voltage comprises:
a compensator comprised in the compensation voltage generation circuit generating a first compensation voltage corresponding to the output voltage according to the output voltage;
a ramp compensator comprised in the compensation voltage generation circuit generating a ramp voltage; and
an adder comprised in the compensation voltage generation circuit adding up the first compensation voltage and the ramp voltage to generate the compensation voltage.

13. The operational method of claim 12, wherein the ramp voltage is used for controlling a minimum operating frequency of the LLC resonant converter.

14. The operational method of claim 11, wherein the common-mode voltage generation circuit generates the common-mode voltage according to the sensing voltage.

15. The operational method of claim 11, wherein the common-mode voltage generation circuit generates the common-mode voltage according to the upper bridge switch control signal and the lower bridge switch control signal.

16. The operational method of claim 11, wherein the controller controls the LLC resonant converter by a current mode.

17. The operational method of claim 11, wherein the upper bridge switch and the lower bridge switch are not turned on simultaneously.

18. The operational method of claim 11, wherein a dead time exists between turning-on time of the upper bridge switch and turning-on time of the lower bridge switch, and the turning-on time of the upper bridge switch is equal to the turning-on time of the lower bridge switch.
